(19) United States
(12) Patent Application Publication
(10) Pub. No.: US 2006/0233240 A1
(43) Pub. Date: Oct. 19, 2006

(54) Context-based adaptive arithmetic coding and decoding methods and apparatuses with improved coding efficiency and video coding and decoding methods and apparatuses using the same

(75) Inventors: Sang-chang Cha, Gyeonggi-do (KR); Kyo-hyuk Lee, Seoul (KR); Woo-jin Han, Gyeonggi-do (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/402,934

(22) Filed: Apr. 13, 2006

Related U.S. Application Data
(60) Provisional application No. 60/670,703, filed on Apr. 13, 2005.

(30) Foreign Application Priority Data
Jun. 14, 2005 (KR) 10-2005-0050944

(51) Int. Cl. H04N 11/04; H04B 1/66; H04N 7/12; H04N 11/02

(52) U.S. Cl. 375/240.03; 375/240.18; 375/240.24

(57) ABSTRACT

Context-based adaptive arithmetic coding and decoding methods and apparatuses with improved coding efficiency using the same are provided. The context-based adaptive arithmetic coding method includes resetting a context model for the given slice to a context model for a slice coded temporally before the given slice, arithmetically encoding a data symbol of the given slice using the reset context model, and updating the context model using a value of the data symbol. The context-based adaptive arithmetic decoding method includes resetting a context model for the given slice to a context model coded temporally before the given slice, arithmetically decoding a bitstream corresponding to the given slice using the reset context model to generate a data symbol of the given slice, and updating the context model using a value of the data symbol.

### CROSS-REFERENCE TO RELATED APPLICATIONS

This application claims priority from Korean Patent Application No. 10-2005-0050944 filed on Jun. 14, 2005 in the Korean Intellectual Property Office, and U.S. Provisional Patent Application No. 60/670,703 filed on Apr. 13, 2005 in the United States Patent and Trademark Office, the disclosures of which are incorporated herein by reference in their entirety.

### BACKGROUND OF THE INVENTION

1. Field of the Invention

Apparatuses and methods consistent with the present invention relate to context-based adaptive arithmetic coding and decoding with improved coding efficiency, and more particularly, to context-based adaptive arithmetic coding and decoding methods and apparatuses providing improved coding efficiency by initializing a context model for a given slice of an input video to a context model for a slice coded (decoded) temporally before the given slice for arithmetic coding and decoding.

2. Description of the Related Art

A video encoder performs entropy coding to convert data symbols representing video input elements into bitstreams suitably compressed for transmission or storage. The data symbols may include quantized transform coefficients, motion vectors, various headers, and the like. Examples of the entropy coding include predictive coding, variable length coding, arithmetic coding, and so on. Particularly, arithmetic coding offers the highest compression efficiency.

Successful entropy coding depends upon accurate probability models of symbols. In order to estimate a probability of symbols to be coded, context-based adaptive arithmetic coding utilizes local, spatial or temporal features. A Joint Video Team (JVT) scalable video model utilizes the context-based adaptive arithmetic coding in which probability models are adaptively updated using the symbols to be coded.

However, the context-based adaptive arithmetic coding method could provide adequate coding efficiency when the information has been accumulated by an increased number of blocks to be coded. However, the conventional context-based adaptive arithmetic coding method has a drawback in that, when a context model is intended to be initialized to a predefined probability model for each slice, unnecessary bits may be consumed to reach a predetermined coding efficiency after the initialization.

### SUMMARY OF THE INVENTION

The present invention provides video coding and decoding methods and apparatuses providing improved coding efficiency by using a context model for a slice having a similar statistical distribution to that of a given slice as an initial value of a context model for the given slice.

The present invention also provides video coding and decoding methods and apparatuses providing improved coding efficiency by encoding and decoding a data symbol using different context models according to the type of a block in a given slice.

The present invention also provides video coding and decoding methods and apparatuses providing improved coding efficiency by transmitting information about an optimum context model for a given slice to a decoder.

The above stated objects as well as other objects, features and aspects of the present invention will become clear to those skilled in the art upon review of the following description.

According to an aspect of the present invention, there is provided a method for performing context-based adaptive arithmetic coding on a given slice in a high-pass frame in a temporal level in a temporally filtered hierarchical structure, the method comprising resetting a context model for the given slice to a context model for a slice coded temporally before the given slice, arithmetically encoding a data symbol of the given slice using the reset context model, and updating the context model using a value of the arithmetically encoded data symbol.

According to another aspect of the present invention, there is provided a method for performing context-based adaptive arithmetic decoding on a given slice in a high-pass frame in a temporal level in a temporally filtered hierarchical structure, the method including resetting a context model for the given slice to a context model decoded temporally before the given slice, arithmetically decoding a bitstream corresponding to the given slice using the reset context model to generate a data symbol of the given slice, and updating the context model using a value of the data symbol.

According to still another aspect of the present invention, there is provided a video coding method including a method for performing context-based adaptive arithmetic coding on a given slice in a high-pass frame in a temporal level in a temporally filtered hierarchical structure, the video coding method including subtracting a predicted image for a block in the given slice from the block and generating a residual, performing spatial transform on the residual to create a transform coefficient, quantizing the transform coefficient, resetting a context model for the given slice to a context model for a slice coded temporally before the given slice, arithmetically encoding a data symbol containing the quantized transform coefficient using the reset context model to generate a bitstream, updating the context model using a value of the arithmetically encoded data symbol, and transmitting the bitstream.

According to yet another aspect of the present invention, there is provided a video decoding method including a method for performing context-based adaptive arithmetic decoding on a given slice in a high-pass frame in a temporal level in a temporally filtered hierarchical structure, the video decoding method including parsing a bitstream and extracting data about a block in the given slice to be reconstructed, resetting a context model for the given slice to a context model for a slice decoded temporally before the given slice, arithmetically decoding a bitstream corresponding to the block using the reset context model to generate a data symbol of the given slice, updating the context model using a value of the data symbol, dequantizing the data symbol to generate a transform coefficient, performing inverse spatial transform on the transform coefficient to reconstruct a residual obtained by subtracting a predicted image from the block, and adding the predicted image reconstructed by motion compensation to the reconstructed residual and reconstructing the block.

According to a further aspect of the present invention, there is provided a method of context-based adaptive arithmetic coding of a video signal, the method including resetting a context model for a given slice to a different context model varying according to a type of a block in the given slice, arithmetically encoding a data symbol of the block using the reset context model, and updating the context model reset according to the type of the block.

According to yet a further aspect of the present invention, there is provided a method of context-based adaptive arithmetic decoding of a video signal, the method including resetting a context model for a given slice including a block to a different context model varying according to a type of the block in the given slice, arithmetically decoding a bitstream corresponding to the block type using a context model corresponding to the block type to generate a data symbol of the given slice, and updating the context model according to the block type using a value of the data symbol.

According to still yet a further aspect of the present invention, there is provided a video coding method comprising subtracting a predicted image for a block from the block and generating a residual, performing spatial transform on the residual to create a transform coefficient, quantizing the transform coefficient, resetting a context model for a given slice comprising the block to a different context model varying model varying according to a type of the block in the given slice comprising the block, arithmetically encoding a data symbol of the block using a context model reset according to the type of the block to generate a bitstream, updating the context model reset according to the type of the block, and transmitting the bitstream.

According to an alternative aspect of the present invention, there is provided a video decoding method including parsing a bitstream and extracting data about a block to be reconstructed, resetting a context model for a given slice containing the block to a different context model varying according to a type of the block in the given slice containing the block, arithmetically decoding a bitstream corresponding to the block using a context model corresponding to the block type to generate a data symbol of the given slice, updating the context model according to the block type using a value of the data symbol, dequantizing the data symbol to generate a transform coefficient, performing inverse spatial transform on the transform coefficient to reconstruct a residual obtained by subtracting a predicted image from the block, and adding the predicted image reconstructed by motion compensation to the reconstructed residual and reconstructing the block.

According to another aspect of the present invention, there is provided a video coding method including subtracting a predicted image for a block from the block and generating a residual, performing spatial transform on the residual to create a transform coefficient, quantizing the transform coefficient, resetting a context model for a given slice containing the block as a predetermined initial value, performing context-based adaptive arithmetic coding on a data symbol of the given slice containing the block using the context model and generating a final probability model, performing another context-based adaptive arithmetic coding on the data symbol of the given slice containing the block using information about the final probability model as an initial value to generate a bitstream, and transmitting the bitstream.

According to yet another aspect of the present invention, there is provided a video decoding method including extracting an initial value of a context model in a given slice containing a block to be reconstructed from a bitstream, resetting a context model for the given slice using the initial value, arithmetically decoding a bitstream corresponding to the block using the reset context model to generate a data symbol of the given slice, updating the context model using a value of the data symbol, dequantizing the data symbol to generate a transform coefficient, performing inverse spatial transform on the transform coefficient to reconstruct a residual obtained by subtracting a predicted image from the block, and adding the predicted image reconstructed by motion compensation to the reconstructed residual and reconstructing the block.

According to still yet another aspect of the present invention, there is provided a video encoder for performing context-based adaptive arithmetic coding on a given slice in a high-pass frame in a temporal level in a temporally filtered hierarchical structure, the video encoder including a unit which subtracts a predicted image for a block in the given slice from the block and generates a residual, a unit which performs spatial transform on the residual to create a transform coefficient, a unit which quantizes the transform coefficient, a unit which resets a context model for the given slice to a context model for a slice coded temporally before the given slice, a unit which arithmetically encodes a data symbol containing the quantized transform coefficient using the reset context model to generate a bitstream, a unit which updates the context model using a value of the arithmetically encoded data symbol, and a unit which transmits the bitstream.

According to another aspect of the present invention, there is provided a video decoder for performing context-based adaptive arithmetic decoding on a given slice in a high-pass frame in a temporal level in a temporally filtered hierarchical structure, the video decoder including a unit which parses a bitstream and extracts data about a block to be reconstructed in the given slice, a unit which resets a context model for the given slice to a context model for a slice decoded temporally before the given slice, a unit which arithmetically decodes a bitstream corresponding to the block using the reset context model to generate a data symbol of the given slice, a unit which updates the context model using a value of the data symbol, a unit which dequantizes the data symbol to generate a transform coefficient, a unit which performs inverse spatial transform on the transform coefficient to reconstruct a residual obtained by subtracting a predicted image from the block, and a unit which adds the predicted image reconstructed by motion compensation to the reconstructed residual and reconstructs the block.

According to another aspect of the present invention, there is provided a video encoder including a unit which subtracts a predicted image for a block to be reconstructed from the block and generates a residual, a unit which performs spatial transform on the residual to create a transform coefficient, a unit which quantizes the transform coefficient, a unit which resets a context model for a slice containing the block to a different context model varying according to the type of the block, a unit which arithmetically encodes a data symbol of the block using a context model reset according to the type of the block to generate a bitstream, a unit which updates the context model reset according to the type of the block, and a unit which transmits the bitstream.

According to still another aspect of the present invention, there is provided a video decoder including a unit which parses a bitstream and extracts data about a block to be reconstructed, a unit which resets a context model for a given slice containing the block to a different context model varying according to the type of the block in the given slice containing the block, a unit which arithmetically decodes the bitstream corresponding to the block using a context model reset according to the type of the block to generate a data symbol of the given slice, a unit which updates the context model reset according to the type of the block using a value of the data symbol, a unit which dequantizes the data symbol to generate a transform coefficient, a unit which performs inverse spatial transform on the transform coefficient to reconstruct a residual obtained by subtracting a predicted image from the block, and a unit which adds the predicted image reconstructed by motion compensation to the reconstructed residual and reconstructing the block.

According to yet another aspect of the present invention, there is provided a video encoder including a unit which subtracts a predicted image for a block from the block and generates a residual, a unit which performs spatial transform on the residual to create a transform coefficient, a unit which quantizes the transform coefficient, a unit which resets a context model for a given slice containing the block as a predetermined initial value, a unit which performs context-based adaptive arithmetic coding on a data symbol of the given slice using the context model and generates a final probability model, a unit which performs another context-based adaptive arithmetic coding on the data symbol of the given slice using information about the final probability model as an initial value to generate a bitstream, and a unit which transmits the bitstream including information about the final probability model.

According to a further aspect of the present invention, there is provided a video decoder including a unit which extracts an initial value of a context model in a slice containing a block to be reconstructed from a bitstream, a unit which resets a context model for the given slice as the initial value, a unit which arithmetically decodes a bitstream corresponding to the block to be reconstructed using the context model to generate a data symbol of the given slice, a unit which updates the context model using a value of the data symbol, a unit which dequantizes the data symbol to generate a transform coefficient, a unit which performs inverse spatial transform on the transform coefficient to reconstruct a residual obtained by subtracting a predicted image from the block, and a unit which adds the predicted image reconstructed by motion compensation to the reconstructed residual and reconstructs the block.

### BRIEF DESCRIPTION OF THE DRAWINGS

The above and other features and advantages of the present invention will become more apparent by describing in detail preferred embodiments thereof with reference to the attached drawings, in which:

FIG. 1 illustrates a context-based adaptive arithmetic coding method according to a first exemplary embodiment of the present invention;

FIG. 2 illustrates a context-based adaptive arithmetic coding method according to a second exemplary embodiment of the present invention;

FIG. 3 illustrates a context-based adaptive arithmetic coding method according to a third exemplary embodiment of the present invention;

FIG. 4 illustrates a context-based adaptive arithmetic coding method according to a fourth exemplary embodiment of the present invention;

FIG. 5 illustrates a context-based adaptive arithmetic coding method according to a fifth exemplary embodiment of the present invention;

FIG. 6 illustrates a context-based adaptive arithmetic coding method according to a sixth exemplary embodiment of the present invention;

FIG. 7 is a flowchart illustrating a video coding method comprising a context-based adaptive coding method according to an exemplary embodiment of the present invention;

FIG. 8 is a flowchart illustrating a video decoding method comprising a context-based adaptive decoding method according to an exemplary embodiment of the present invention;

FIG. 9 is a flowchart illustrating a video coding method comprising a context-based adaptive coding method according to an exemplary embodiment of the present invention;

FIG. 10 is a flowchart illustrating a video decoding method comprising a context-based adaptive decoding method according to an exemplary embodiment of the present invention;

FIG. 11 is a flowchart illustrating a video coding method comprising a context-based adaptive arithmetic coding method according to an exemplary embodiment of the present invention, which includes transmitting data on optimum context model to a decoder;

FIG. 12 is a flowchart illustrating a video decoding method comprising a context-based adaptive arithmetic decoding method according to an exemplary embodiment of the present invention, which includes receiving data about optimum context model;

FIG. 13 is a block diagram of a video encoder according to an exemplary embodiment of the present invention; and

FIG. 14 is a block diagram of a video decoder according to an exemplary embodiment of the present invention.

### DETAILED DESCRIPTION OF THE EXEMPLARY EMBODIMENTS

Aspects and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

The present invention will now be described more fully with reference to the accompanying drawings, in which exemplary embodiments of the invention are shown.

Context-based Adaptive Binary Arithmetic Coding (CABAC) achieves high compression performance by selecting a probability model for each symbol based on a symbol context, adapting probability estimates corresponding to the probability model based on local statistics and performing arithmetic coding on the symbol. The coding process of the data symbol consists of at most four elementary steps: 1. Binarization; 2. Context modeling; 3. Arithmetic coding; and 4. Probability updating.

1. Binarization

Among CABAC techniques, binary arithmetic coding allows a given non-binary valued symbol to be uniquely mapped to a binary sequence. In CABAC, only a binary decision enters a coding process. Non-binary valued symbols, such as transform coefficients or motion vectors, are converted into binary codes prior to the actual arithmetic coding process. This process is similar to converting data symbols to variable length codes except that the binary codes are previously encoded by an arithmetic encoder prior to transmission.

For brevity, the present invention will now be discussed along with details on CABAC set forth but the invention is not limited thereto.

The following elementary operations of context modeling, arithmetic coding, and probability updating are recursively performed on the respective bits of the binarized codes, i.e., bins.

2. Context Model Selecting

A context model, which is a probability model for one or more bins of binarized symbols and chosen based on the recently coded data symbol statistics, stores a probability for each bin to be “1” or “0.”

3. Arithmetic Coding

An arithmetic encoder codes each bin based on the chosen probability model. Each bin has only two probability sub-ranges corresponding to values of “1” and “0,” respectively.

4. Probability Updating.

The chosen probability model is updated using actually coded values. That is to say, if the bin value is “1,” the frequency count of 1's is incremented by one.

In the above-described CABAC technique, since context modeling is performed in units of slices, probability values of context models are initialized using fixed tables at the start of each slice. Compared to the conventional variable length coding (VLC) technique, to offer a higher coding efficiency, the CABAC technique requires that a predetermined amount of information accumulates such that context models are constantly updated using the statistics of the recently coded data symbols. Thus, initializing context models for each slice using predefined probability models may result in unnecessary consumption of bits until degraded performance is traded off as the number of coded block increases.

Data symbols of a given slice to be currently coded tend to have a statistical distribution similar to that of data symbols of a slice that has recently been coded. Thus, there is provided an improved CABAC technique which reduces degradation in the coding efficiency immediately after initializing a context model using statistical characteristics of a slice coded temporally before the given slice as an initial value of a context model for the given slice.

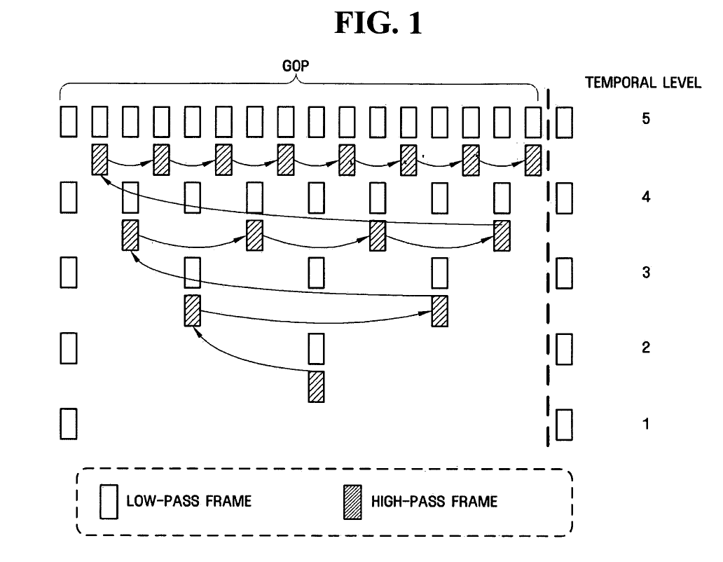

FIG. 1 illustrates a context-based adaptive arithmetic coding method according to a first exemplary embodiment of the present invention.

In the temporally filtered hierarchical structure, high-pass frames tend to have similar statistical characteristics with one another. Thus, a context model for a slice coded immediately before the given slice may be used as an initial value of a context model for the current high-pass frame slice. Here, the high-pass frames are encoded in the order from the lowest temporal level to the highest temporal level consecutively using a context model for a slice coded immediately before the given slice as an initial value of a context model for the given slice. When a frame is divided into two or more slices, a slice coded immediately before a given slice may indicate a corresponding slice of a neighboring high-pass frame in the same temporal level or a slice coded immediately before the given slice in the same high-pass frame. In describing exemplary embodiments of FIGS. 1 to 6, it is assumed that each frame is made of one slice.

As shown in FIG. 1, in the temporally filtered hierarchical structure, slices in a high-pass frame are encoded in the order from the lowest temporal level to the highest temporal level while consecutively referring to a context model for a slice coded immediately before a given slice as an initial value of a context model for the given slice. Arrows shown in FIGS. 1 through 6 indicate directions in which context models are referred to. In other words, the context model for a slice coded immediately before a given slice is used as an initial value of a context model for the given slice.

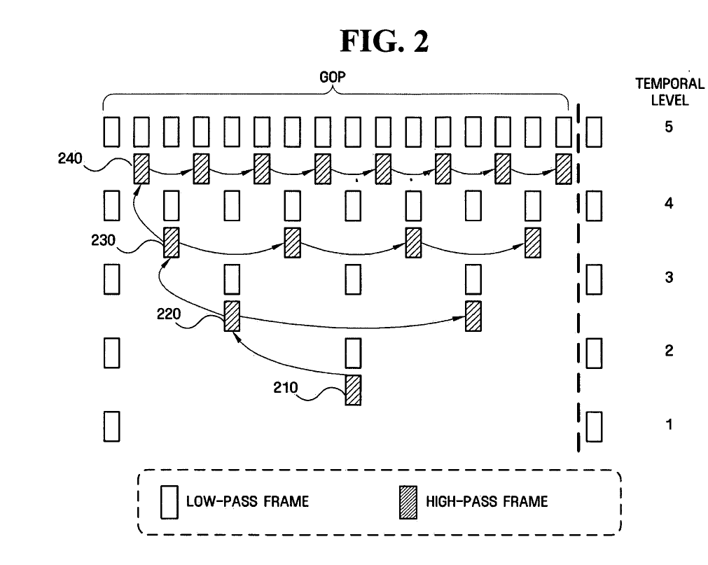

FIG. 2 illustrates a context-based adaptive arithmetic coding method according to a second exemplary embodiment of the present invention.

In the illustrated second exemplary embodiment of the present invention, a given slice in a high-pass frame in the same temporal level consecutively uses a context model for a slice coded temporally immediately before the given slice, thereby alleviating degradation of coding efficiency due to initialization of the context model, which is the same as described above in the first exemplary embodiment. A difference is that slices 240, 230, and 220 can respectively use as initial models context models for their closest slices 230, 220, and 210 in high-pass frames in lower temporal levels coded immediately before slices 240, 230 and 220. Thus, the method of the second exemplary embodiment can reduce error propagation among the slices within the same temporal level compared to the method of the first exemplary embodiment.

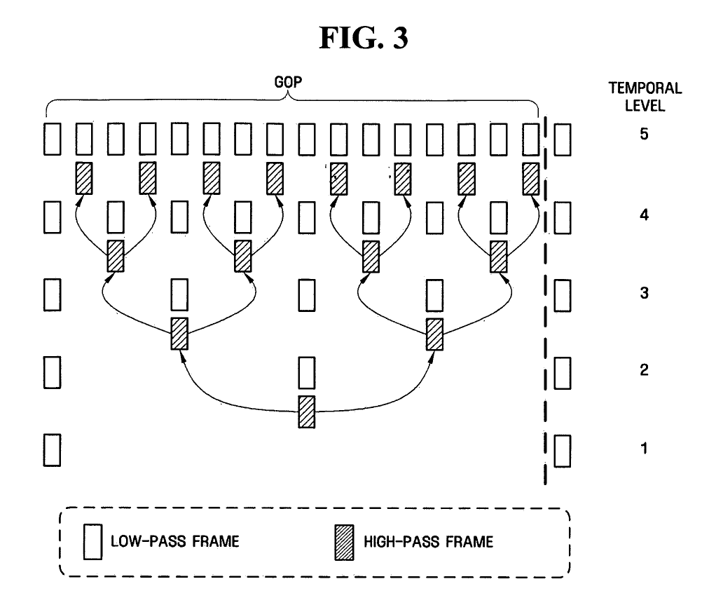

FIG. 3 illustrates a context-based adaptive arithmetic coding method according to a third exemplary embodiment of the present invention.

When a sharp scene change is detected from video inputs, statistical characteristics of a slice that has been coded immediately before a given slice are different from those of the given slice. Thus, the context-based adaptive arithmetic coding method according to the third exemplary embodiment of the present invention can provide for high coding efficiency by using statistical information on a slice in a lower level that is temporally closest to the given slice. Further, the method of the third exemplary embodiment can reduce error propagation compared to the methods of the first and second exemplary embodiments because an error occurring within a slice can propagate to only a slice at a higher level that uses the slice as a reference.

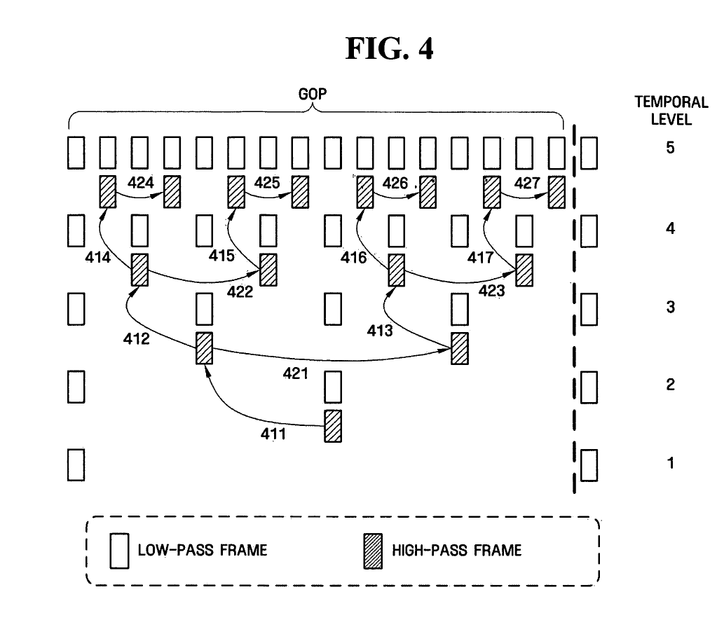

FIG. 4 illustrates a context-based adaptive arithmetic coding method according to a fourth exemplary embodiment of the present invention.

The context-based adaptive arithmetic coding method shown in FIG. 4 takes advantage of merits and effects of both the methods shown in FIGS. 2 and 3. That is, arithmetic coding for an odd-numbered high-pass frame is performed using a context model for a slice in a temporally closest high-pass frame in a lower level as an initial value for the odd-numbered high-pass frame, as indicated by arrows labeled 411 through 417, while arithmetic coding for an even-numbered high-pass frame is performed using a context model for a slice in the same temporal level coded immediately before the given slice, as indicated by arrows labeled 421 through 427. The method according to the fourth exemplary embodiment has advantages of reducing error propagation among slices and using similar statistical characteristics of a previous slice.

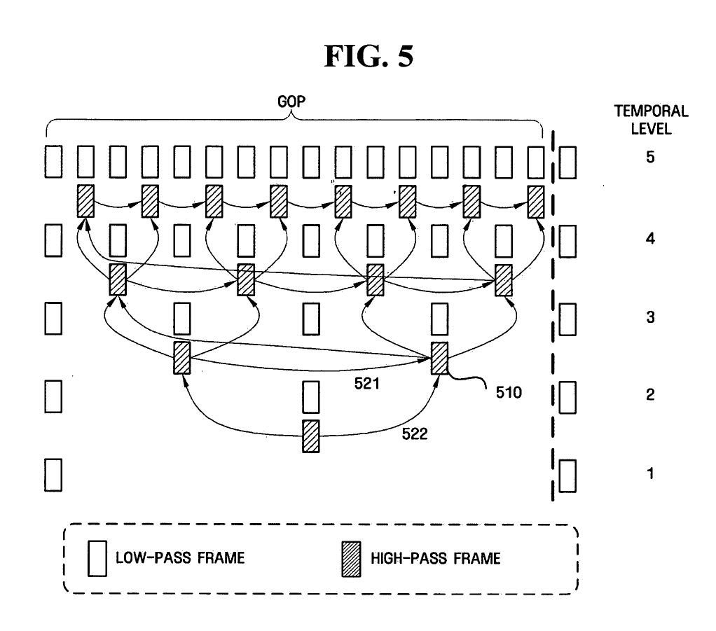

FIG. 5 illustrates a context-based adaptive arithmetic coding method according to a fifth exemplary embodiment of the present invention, in which one of context models for slices, which are coded temporally before the given slice and have similar statistical characteristics to those of the given slice, is selected for arithmetic coding of the given slice. That is, the method according to the fifth exemplary embodiment includes selecting a context model that offers the highest coding efficiency among context models used in the first through fourth exemplary embodiments and performing arithmetic coding according to the selected model. Referring to FIG. 5, in order to perform arithmetic coding on a slice 510, one of an experimentally predefined initial value, a context model for a slice at the same level (521) coded immediately before the slice 510, and a context model for a slice in a lower level (522) temporally closest to the given slice is selected as an initial value of a context model for the slice 510.

In the fifth exemplary embodiment of the present invention, information about whether a predefined initial value has been used as an initial value of a context model for the given slice, and information about a referred context model for a certain slice when statistical information of the slice coded temporally before the given slice has been used in arithmetic coding, are inserted into the bitstream for being transmitted to a decoder.

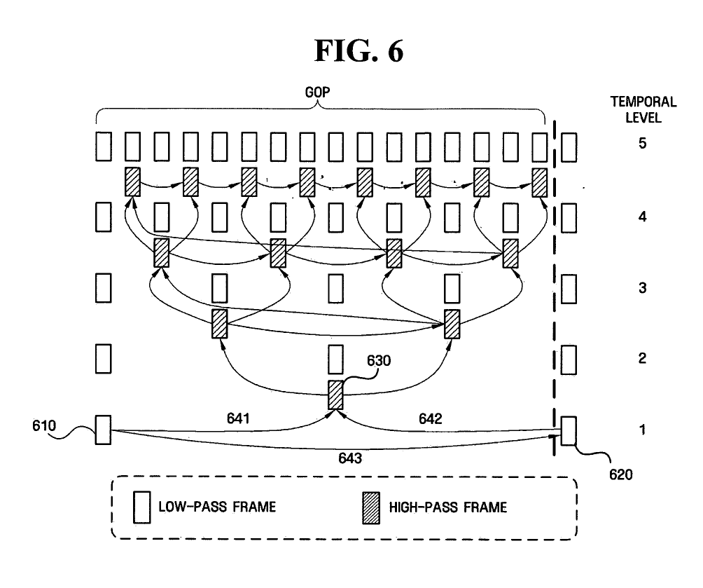

FIG. 6 illustrates a context-based adaptive arithmetic coding method according to a sixth exemplary embodiment of the present invention.

Context-based adaptive arithmetic coding is performed on a slice 630 in a first high-pass frame using statistical information about slices 610 and 620 in a low-pass frame (641 and 642). On the other hand, the context-based adaptive arithmetic coding is also performed on a slice 620 in a low-pass frame in a neighboring group of pictures (GOP) using statistical information about the slice 610 in the previously coded low-pass frame. In this case, an encoder can insert information about a context model for a slice used as a reference for the slice 630 in the first high-pass frame in a GOP and information about whether the slice 620 in the low-pass frame in the neighboring GOP is subjected to arithmetic coding with reference to the context model for the slice 610 in the previously coded low-pass frame into a bitstream for transmission to a decoder.

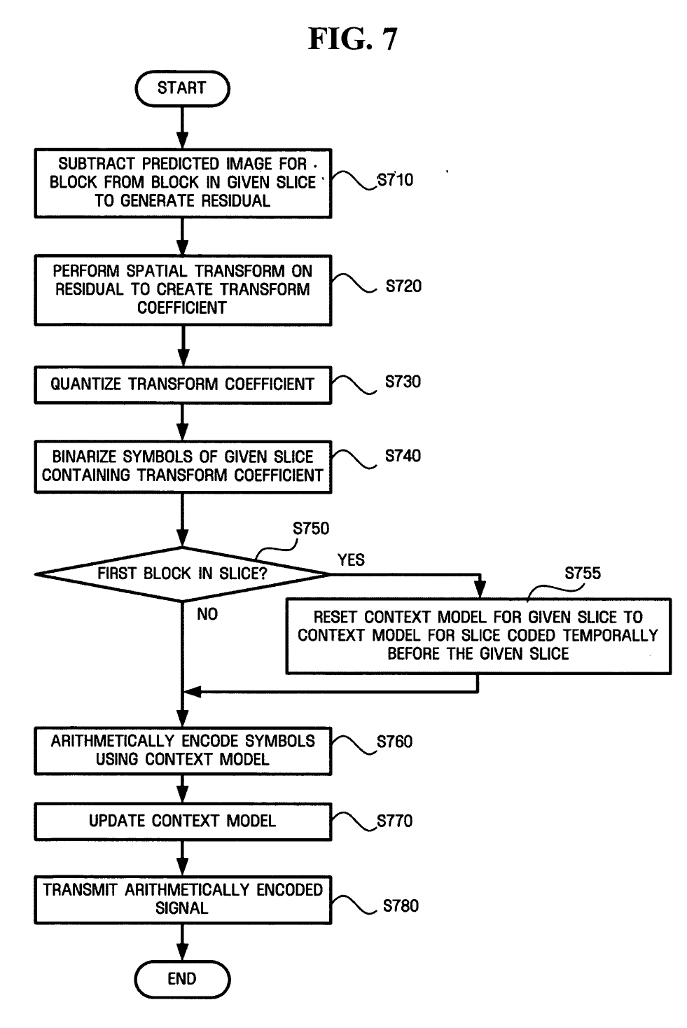

FIG. 7 is a flowchart illustrating a video coding method including a context-based adaptive coding method according to an exemplary embodiment of the present invention.

The video coding method includes subtracting a predicted image for a block from the block in a given slice to be compressed to generate a residual signal (step S710), performing spatial transform on the residual signal to create a transform coefficient (step S720), quantizing data symbols including a transform coefficient and a motion vector obtained during generation of the predicted image (step S730), entropy coding the quantized data symbols (steps S740 through S770), and transmitting an arithmetically encoded signal to a decoder (step S780).

The entropy coding process includes binarization (step S740), resetting of a context model (step S755), arithmetic coding (step S760), and update of a context model (step S770). However, when context-based adaptive arithmetic coding is used instead of CABAC, the binarization step S740 may be skipped.

In the binarization step S740, a data symbol having a non-binary value is converted or binarized into a binary value.

When the currently compressed block is a first block in the slice in the step S750, a context model for the slice is reset in the step S755. The entropy coding is performed in units of blocks and a context model is reset in units of slices to ensure independence of slices. In other words, the context model is reset for symbols of the first block in the slice. As the number of blocks to be coded increases, context models corresponding thereto are adaptively updated. In the present exemplary embodiment, a selected context model is reset by referring to a context model for a slice coded temporally before the given slice, which is as described above.

Examples of a slice that will be used to reset a context model for a given slice are shown in FIGS. 1 through 6. A video coding method including the arithmetic coding method according to the sixth embodiment of the present invention, as shown in FIG. 6, may further include selecting one of context models available for reference. Criteria of selecting one of context models available for reference include coding efficiency, an error propagation probability, and so on. In other words, a context model having highest coding efficiency, or a context model having least error propagation probability, may be selected among context model candidates.

In the step S760, the binarized symbol is subjected to arithmetic coding according to a probability model having a context model for the slice coded temporally before the given slice as an initial value.

In the step S770, the context model is updated using the actual value of the binarized symbol. For example, if one bin of the data symbol has a value of “0,” the frequency count of 0's is increased. Thus, the next time this model is selected, the probability of a “0” will be slightly higher.

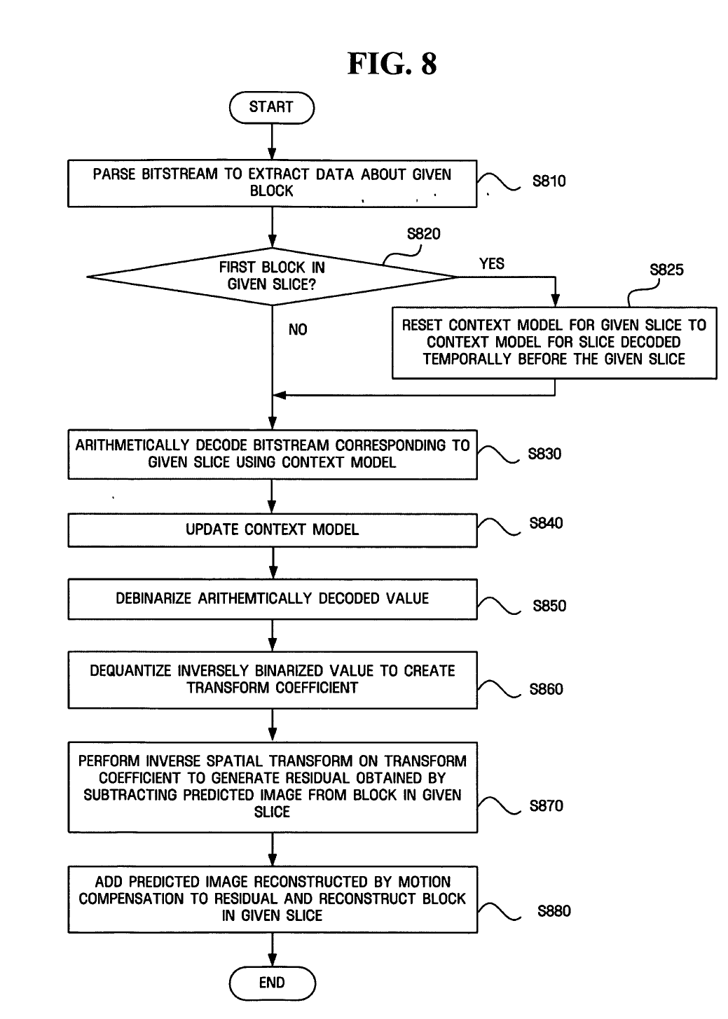

FIG. 8 is a flowchart illustrating a video decoding method including a context-based adaptive decoding method according to an exemplary embodiment of the present invention.

In step S810, a decoder parses a received bitstream and extracts data for a given block to be reconstructed. The data may include information about a selected context model, for example, slice information of the selected context model when a context model of a slice out of slices coded temporally before the given slice is selected for initialization of a context model of the given slice during arithmetic coding performed by an encoder.

When the given block is a first block in a slice (YES in step S820), a context model for the given slice is reset to a context model for a slice decoded temporally before the given slice in step S825. Examples of a slice that will be used to reset a context model for the given slice are as shown in FIGS. 1 through 6. If the given slice was coded according to the fifth or sixth exemplary embodiment, the context model for the given slice can be reset according to the information about a referred slice extracted from the bitstream.

In step S830, a bitstream corresponding to the block is arithmetically decoded according to the context model. In step S840, the context model is updated using the actual value of the decoded data symbol. When context-based adaptive binary arithmetic decoding is used, the arithmetically decoded data symbol is converted or inversely binarized into a non-binary value in step S850.

In step S860, inverse quantization is performed on the inversely binarized data symbol to generate a transform coefficient and, in step S870, inverse spatial transform is performed on the transform coefficient to reconstruct a residual signal for the given block. In step S880, a predicted image for the given block reconstructed by motion compensation is added to the reconstructed residual signal, thereby reconstructing the given block.

In order to increase coding efficiency in CABAC, different context models varying according to the type of a block in a slice can be used. The block in a slice is classified into an inter-prediction mode block, an intra-prediction mode block or an intra base layer (BL) prediction mode block according to a block prediction mode. A block will have different statistical characteristics depending on which mode is used in predicting the block, which will be described below by way of example. If a consideration is taken into statistical characteristics depending on the type of a block prediction mode in CABAC, coding efficiency can be further enhanced.

In the joint scalable video model (JSVM), four models, that is, map, last, sign and level are used for coding a residual signal. The model “map” indicates whether a non-zero value exists in a given position or not. The model “last” confirms that the current position is the last one in the map. The model “sign” indicates a sign of a value in the current position. The model “level” indicates the absolute value of a value of the current position. In addition, a Coded Block Pattern (CBP) indicates whether or not there is a meaningful value in the given block, and deltaQP indicates a difference between a predetermined quantization parameter and a quantization parameter selected from the given block. These signals have different statistical characteristics depending on block types. Thus, CABAC can be performed while maintaining different context models for such signals varying according to block types and independently updating the signals.

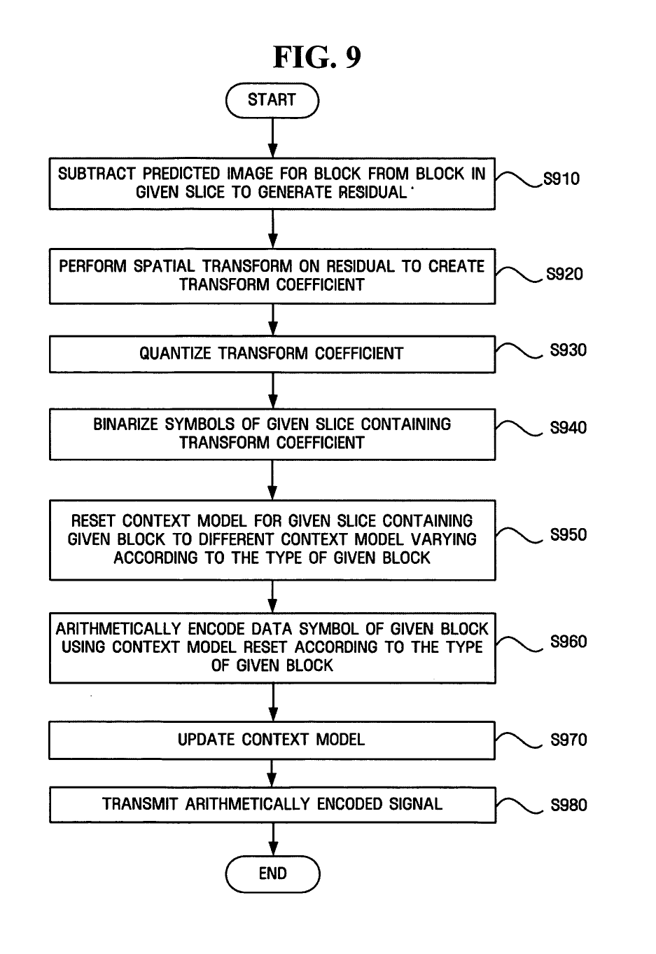

FIG. 9 is a flowchart illustrating a video coding method including a context-based adaptive coding method according to another exemplary embodiment of the present invention.

The video coding method includes subtracting a predicted image for a block from the block in a given slice to generate a residual (step S910), performing spatial transform on the residual to create a transform coefficient (step S720), quantizing the transform coefficient (step S730), and entropy coding the quantized transform coefficient (steps S940 through S970), and transmitting an arithmetically encoded signal to a decoder (step S980).

The entropy coding process is segmented into steps 940 through S970. In the step S940, data symbols including a transform coefficient and a motion vector are binarized. The binarization step S940 may be skipped when a CABAC method is not used. In the step S950, a context model for a given slice containing a given block is initialized to a different context model varying according to the type of the block in the given slice. In step S960, the data symbol of the given block is arithmetically encoded using a context model chosen according to the type of the block and, in step S970, the context model corresponding to the type of the block is updated. This means that data symbols of one slice can be encoded using a set of one or more context models. In step S980, the arithmetically encoded signal is transmitted to a decoder.

Meanwhile, the different context model varying according to the type of the block in the slice is initialized into a context model for a slice coded temporally before the given slice, which has been described above in detail with reference to FIGS. 1 through 6. In other words, the context model for an inter-prediction mode block can use a context model for an inter-prediction mode block in the slice coded temporally before the given slice as an initialization value.

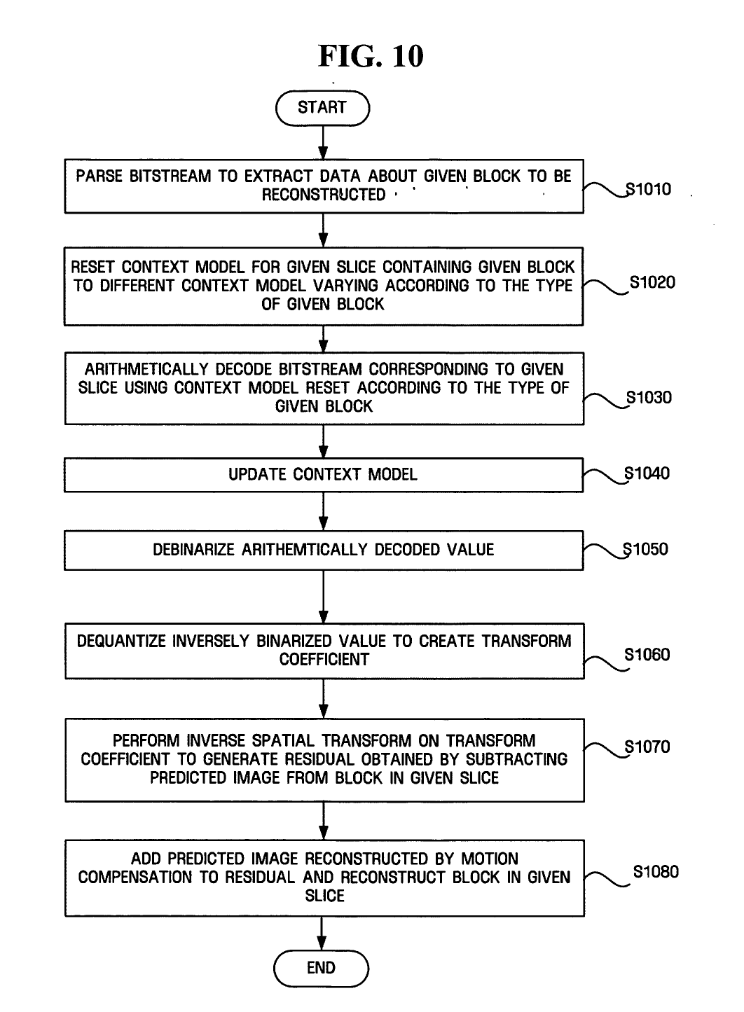

FIG. 10 is a flowchart illustrating a video decoding method including a context-based adaptive decoding method according to another exemplary embodiment of the present invention.

In step S1010, a received bitstream is parsed and data for a given block to be reconstructed is extracted. In steps S1020 through S1050, entropy decoding is performed on the given block. In step S1060, the entropy decoded value is dequantized to generate a transform coefficient. Inverse spatial transform is performed on the transform coefficient in step S1070 and the given block is reconstructed in step S1080. The entropy decoding process sub-divided into steps S1020 through S1050 will be described as follows.

In step S1020, a context model for a given slice containing the given block is reset to a different context model varying according to the type of the block in the given slice. Here, the different context models varying according to the type of the block in the given slice can be reset to a context model for the same block type slice decoded temporally before the given slice. A method of referring to a context model for a different slice prior to initialization is the same as that described above with reference to FIGS. 1 through 6. For example, when an encoder chooses one of context models available for reference and transmits information about a slice having the chosen context model to a decoder, the decoder may parse information about the reference slice in step S1010 and reset a context model for the given slice to the context model for the reference slice in step S1020.

When the given block to be decoded is an inter-prediction mode block, the decoder arithmetically decodes a bitstream corresponding to the given block using a context model for the inter-prediction mode block in step S1030 and updates the context model in step S1040. When context-based adaptive binary arithmetic decoding is used, the arithmetically decoded value is converted or inversely binarized into a non-binary value in step S1050.

In order to improve the performance of context-based adaptive arithmetic coding, information about a finally updated probability model is simplified before being transmitted to a decoder.

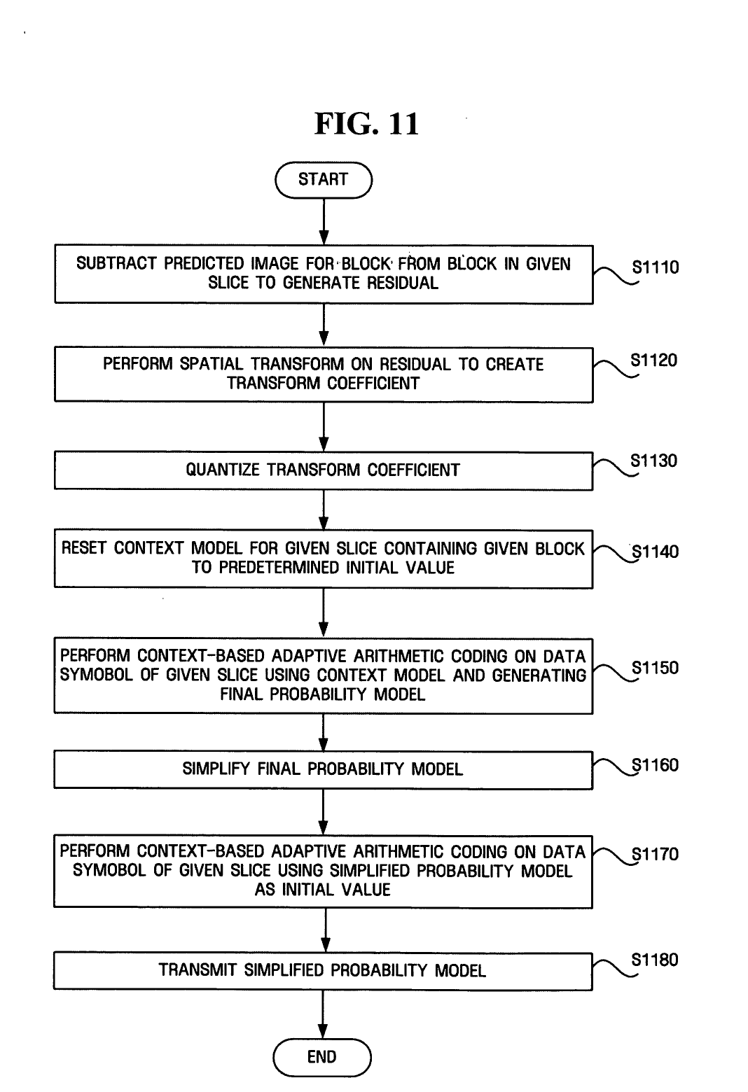

FIG. 11 is a flowchart illustrating a video coding method including a context-based adaptive arithmetic coding method according to an exemplary embodiment of the present invention, in which simplified information about a final probability model is transmitted and context-based adaptive arithmetic coding is performed using the simplified information as an initial value.

The video coding method includes subtracting a predicted image for a given block from the given block to generate a residual (step S1110), performing spatial transform on the residual to create a transform coefficient (step S1120), quantizing the transform coefficient (step S1130), and performing context-based adaptive arithmetic coding on a data symbol of the given block including the quantized transform coefficient (steps S1140 through S1170), and transmitting information about an initial value of a context model to a decoder (step S1380).

An encoder initializes a context model for a given slice containing the given block to a predetermined initial value in step S1140 and arithmetically encodes data symbols of the given slice and updates the context model using a typical context-based adaptive arithmetic coding method in step S1150. Here, the predetermined initial value may be an optimal probability model experimentally obtained by encoding a plurality of general images or a context model for a slice having similar statistical characteristics to those of the given slice.

A final context model obtained by the update step (S1150) may be considered as the optimum context model for the given slice, thus information about the final context model is transmitted to the decoder in step S1180. Information about the final context model may be the context model itself or a difference between either the initial value or a context model for a base layer slice corresponding to the given slice and the context model for the given slice (step S1160).

That is, in order to reduce the amount of data to be transmitted, it is possible to transmit only the difference between either the initial value or the probability model for the base layer slice and the information about the context model for the given slice that mostly affects the amount of data to be transmitted. In step S1170, the data symbols of the given slice is subjected to context-based adaptive arithmetic coding using the final context model or the probability model obtained by simplifying the final context model as an initial value before being transmitted to the decoder.

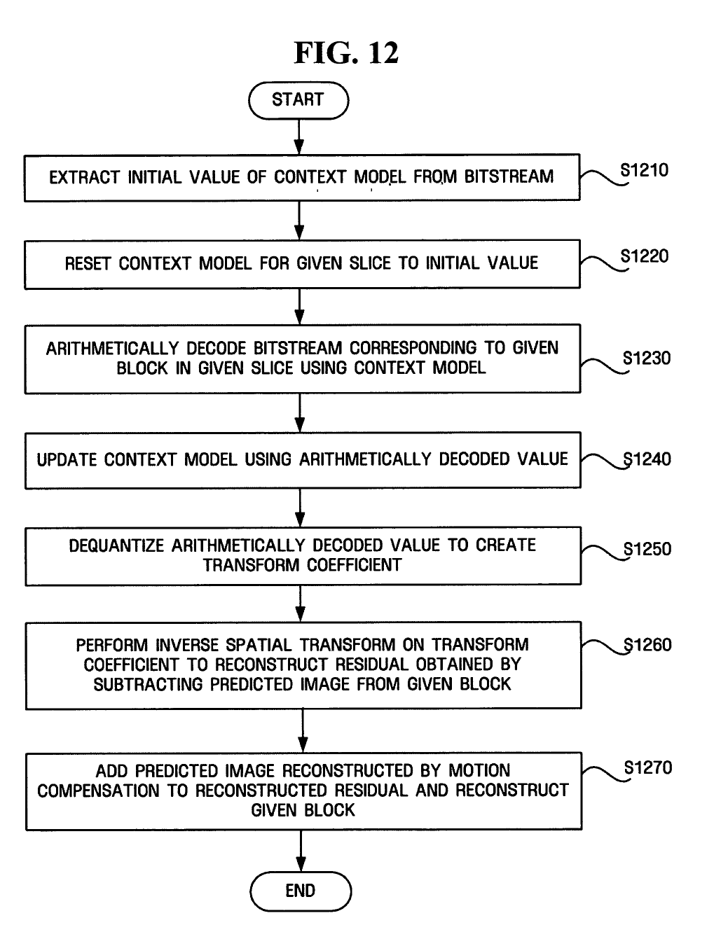

FIG. 12 is a flowchart illustrating a video decoding method including a context-based adaptive arithmetic decoding method using information about a final probability model, which corresponds to the video encoding method shown in FIG. 11.

The video decoding method includes extracting an initial value of a context model from a bitstream (step S1210), resetting a context model for a given slice as the initial value (step S1220), performing context-based adaptive arithmetic decoding on a bitstream corresponding to a given block in the given slice (step S1230), updating the context model using the arithmetically decoded value (step S1240), dequantizing the arithmetically decoded value (step S1250), performing inverse spatial transform on a transform coefficient to reconstruct a residual signal (step S1260), and adding a reconstructed predicted image to the residual signal and the given block is reconstructed (step S1270). The initial value of the context model is information about the final probability model obtained using the process described above with reference to FIG. 11.

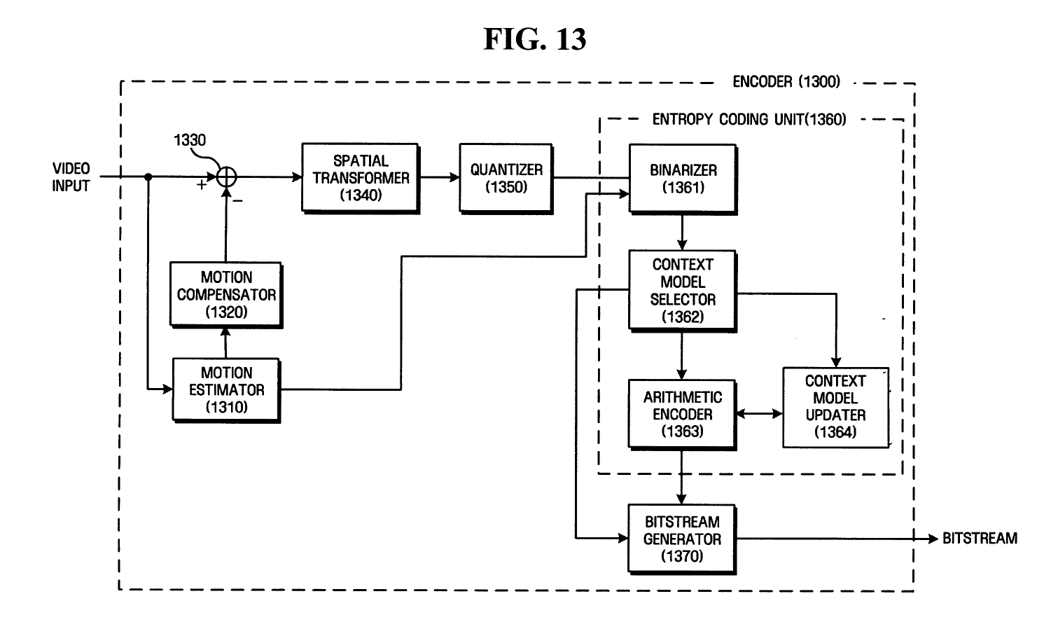

FIG. 13 is a block diagram of a video encoder 1300 according to an embodiment of the present invention.

The video encoder 1300 includes a spatial transformer 1340, a quantizer 1350, an entropy coding unit 1360, a motion estimator 1310, and a motion compensator 1320.

The motion estimator 1310 performs motion estimation on a given frame among input video frames using a reference frame to obtain motion vectors. A block matching algorithm is widely used for the motion estimation. In detail, a given motion block is moved in units of pixels within a particular search area in the reference frame, and displacement giving a minimum error is estimated as a motion vector. For motion estimation, hierarchical variable size block matching (HVSBM) may be used. However, in exemplary embodiments of the present invention, simple fixed block size motion estimation is used. The motion estimator 1310 transmits motion data such as motion vectors obtained as a result of motion estimation, a motion block size and a reference frame number to the entropy coding unit 1360.

The motion compensator 1320 reduces temporal redundancy within the input video frame. In this case, the motion compensator 1320 performs motion compensation on the reference frame using the motion vector calculated by the motion estimator 1310 and generates temporally estimated frame for the given frame.

A subtractor 1330 calculates a difference between the given frame and a temporally predicted frame and temporal redundancy is removed from the input video frame.

The spatial transformer 1340 uses spatial transform technique supporting spatial scalability to remove spatial redundancy within the frame in which temporal redundancy has been removed by the subtractor 1330. The spatial transform method may include a Discrete Cosine Transform (DCT), or wavelet transform. Spatially-transformed values are referred to as transform coefficients.

The quantizer 1350 applies quantization to the transform coefficient obtained by the spatial transformer 1340. Quantization means the process of expressing the transform coefficients formed in arbitrary real values by discrete values, and matching the discrete values with indices according to the predetermined quantization table. The quantized result value is referred to as a quantized coefficient.

The entropy coding unit 1360 losslessly encodes data symbols including the quantized transform coefficient obtained by the quantizer 1350 and the motion data received from the motion estimator 1310. The entropy coding unit 1360 includes a binarizer 1361, a context model selector 1362, an arithmetic encoder 1363, and a context model updater 1364.

The binarizer 1361 converts the data symbols into a binary value that is then sent to the context model selector 1362. The binarizer 1361 may be omitted when CABAC is not used.

The context model selector 1362 selects either an initial value predefined as an initial value of a context model for a given slice or a context model for a slice coded temporally before the given slice. Information about the selected initial value of the context model is sent to a bitstream generator 1370 and inserted into a bitstream for transmission. Meanwhile, when a method of referring to slices coded temporally before the given slice in order to initialize a context model for a given slice is predefined between an encoder part and a decoder part, the context model selector 1362 may not be provided.

The arithmetic encoder 1363 performs context-based adaptive arithmetic coding on data symbols of the given block using the selected context model. In exemplary embodiments of the present invention, arithmetic coding is performed on a data symbol of the slice using different context models varying according to the type of the block in the given slice. In alternative embodiments of the present invention, a final probability model is generated by performing context-based adaptive arithmetic coding and context-based adaptive arithmetic coding is performed on the data symbol of the slice using the final probability model as an initial value. In this case, information about the final probability model is transmitted to the bitstream generator 1370 to then be transmitted to a decoder.

The context model updater 1364 updates the context model using a value of the arithmetically encoded data symbol. In exemplary embodiments of the present invention, the context model corresponding to the block type of the given block is updated.

To support closed-loop video encoding to reduce a drifting error caused due to a mismatch between an encoder and a decoder, the video encoder 1300 may further include a dequantizer and an inverse spatial transformer.

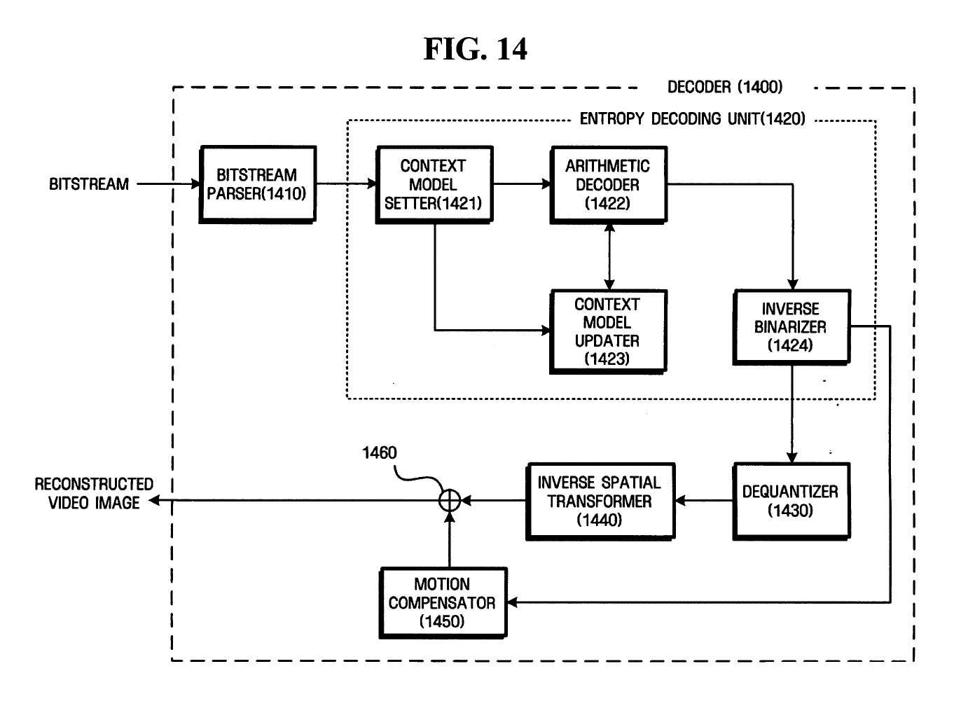

FIG. 14 is a block diagram of a video decoder 1400 according to an exemplary embodiment of the present invention.

The video decoder 1400 includes a bitstream parser 1410, an entropy decoding unit 1420, a dequantizer 1430, an inverse spatial transformer 1440, and a motion compensator 1450.

The bitstream parser 1410 parses a bitstream received from an encoder to extract information needed for the entropy decoding unit 1420 to decode the bitstream.

The entropy decoding unit 1420 performs lossless decoding that is the inverse operation of entropy coding to extract motion data that are then fed to the motion compensator 1450 and texture data that are then fed to the dequantizer 1430. The entropy decoding unit 1420 includes a context model setter 1421, an arithmetic decoder 1422, a context model updater 1423, and an inverse binarizer 1424.

The context model setter 1421 initializes a context model for a slice to be decoded according to the information extracted by the bitstream parser 1410. The information extracted by the bitstream parser 1410 may contain information about a slice having a context model to be used as an initial value of a context model for a given slice and information about a probability model to be used as the initial value of the context model for the given slice. In exemplary embodiments of the present invention, context models independent of the type of a block in a slice may be initialized.

The arithmetic decoder 1422 performs context-based adaptive arithmetic decoding on a bitstream corresponding to data symbols of the given slice according to the context model set by the context model setter 1421. In exemplary embodiments of the present invention, arithmetic decoding may be performed using different context models varying according to the type of a block to be decoded.

The context model updater 1423 updates the current context model using a value of the arithmetically decoded data symbol. Alternatively, the context model updater 1423 may update a context model selected according to the type of the decoded block.

When context-based adaptive binary arithmetic decoding is used, the inverse binarizer 1424 converts the decoded binary values obtained by the arithmetic decoder 1422 into non-binary values.

The dequantizer 1430 dequantizes texture information received from the entropy decoding unit 1420. The dequantization is a process of obtaining quantized coefficients from matched quantization indices received from the encoder.

The inverse spatial transformer 1440 performs inverse spatial transform on coefficients obtained after the dequantization to reconstruct a residual image in a spatial domain. The motion compensator 1450 performs motion compensation on the previously reconstructed video frame using the motion data from the entropy decoding unit 1420 and generates a motion-compensated frame. The motion compensation is restrictively applied to a case where the given frame is coded through temporal estimation in the encoder part.

When the residual image reconstructed by the inverse spatial transformer 1440 is generated using temporal prediction, an adder 1460 adds a motion-compensated image received from the motion compensator 1450 to the residual image and a video frame is reconstructed.

In FIGS. 13 through 14, various components mean, but are not limited to, software or hardware components, such as a Field Programmable Gate Arrays (FPGAs) or Application Specific Integrated Circuits (ASICs), which perform certain tasks. The components may advantageously be configured to reside on the addressable storage media and configured to execute on one or more processors. The functionality provided for in the components and modules may be combined into fewer components and modules or further separated into additional components and modules.

As described above, context-based adaptive arithmetic coding and decoding methods and apparatuses of the present invention according to the present invention provides at least the following advantages.

First, the video coding and decoding methods and apparatuses of the present invention can improve the overall coding efficiency by consecutively using a context model for a slice having similar statistical characteristics to those of a given slice.

Second, the video coding and decoding methods can improve overall coding efficiency by encoding a data symbol using different context models varying according to the type of the block in a slice.

Third, the video coding method and apparatus also provide for improved coding efficiency by transmitting information about an optimum context model for the given slice to a decoder.

In concluding the detailed description, those skilled in the art will appreciate that many variations and modifications can be made to the preferred embodiments without substantially departing from the principles of the present invention. Therefore, the disclosed preferred embodiments of the invention are used in a generic and descriptive sense only and not for purposes of limitation.

What is claimed is:

1. A method for performing context-based adaptive arithmetic coding on a given slice in a high-pass frame of a video signal, the method comprising:
resetting a context model for the given slice to a context model for a slice coded temporally before the given slice;
arithmetically encoding a data symbol of the given slice using the reset context model; and
updating the context model using a value of the arithmetically encoded data symbol.

2. The method of claim 1, further comprising binarizing the data symbol, wherein in the arithmetically encoding of the data symbol of the given slice, the data symbol of the given slice is the binarized data symbol.

3. The method of claim 1, wherein the slice coded temporally before the given slice is a slice coded immediately before the given slice.

4. The method of claim 1, wherein the slice coded temporally before the given slice is a slice in a lower level that is temporally closest to the given slice.

5. The method of claim 1, wherein the slice coded temporally before the given slice is a slice in a low-pass frame.

6. The method of claim 1, further comprising selecting one of context models for at least two slices coded temporally before the given slice, wherein in the resetting of the context model for the given slice, the context model for the slice coded temporally before the given slice is the selected context model.

7. The method of claim 1, further comprising determining whether the data symbol is a symbol for a first block among a plurality of blocks if the given slice comprises the plurality of blocks,
wherein if the data symbol is not the symbol for the first block of the plurality of blocks, the resetting does not occur and the arithmetic encoding is performed using the updated context model.

8. A method for performing context-based adaptive arithmetic coding on a given slice in a low-pass frame of a video signal, the method comprising:
resetting a context model for the given slice to a context model for a slice coded temporally before the given slice;
arithmetically encoding a data symbol of the given slice using the reset context model; and
updating the context model using a value of the arithmetically encoded data symbol.

9. A method for performing context-based adaptive arithmetic decoding on a given slice in a high-pass frame of a video signal, the method comprising:
resetting a context model for the given slice to a context model decoded temporally before the given slice;
arithmetically decoding a bitstream corresponding to the given slice using the reset context model to generate a data symbol of the given slice; and
updating the context model using a value of the data symbol.

10. The method of claim 9, further comprising inverse-binarizing the data symbol.

11. The method of claim 9, wherein the slice decoded temporally before the given slice is a slice decoded immediately before the given slice.

12. The method of claim 9, wherein the slice decoded temporally before the given slice is a slice in a lower level temporally closest to the given slice.

13. The method of claim 9, wherein the slice decoded temporally before the given slice is a slice in a low-pass frame.

14. The method of claim 9, further comprising determining whether the bitstream comprises a data symbol for a first block among a plurality of blocks if the given slice comprises the plurality of blocks,
wherein if the bitstream does not comprise the data symbol for the first block of the plurality of blocks, the resetting does not occur and the arithmetic decoding is performed using the updated context model.

15. A method for performing context-based adaptive arithmetic decoding on a given slice in a low-pass frame of a video signal, the method comprising:
resetting a context model for the given slice to a context model for a slice decoded temporally before the given slice;
arithmetically decoding a bitstream corresponding to the given slice using the reset context model to generate a data symbol of the given slice; and
updating the context model using a value of the data symbol.

16. A video coding method comprising a method for performing context-based adaptive arithmetic coding on a given slice in a high-pass frame in a temporal level in a temporally filtered hierarchical structure, the video coding method comprising:
subtracting a predicted image for a block in the given slice from the block and generating a residual;
performing spatial transform on the residual to create a transform coefficient;
quantizing the transform coefficient;
resetting a context model for the given slice to a context model for a slice coded temporally before the given slice;
arithmetically encoding a data symbol comprising the quantized transform coefficient using the reset context model to generate a bitstream;
updating the context model using a value of the arithmetically encoded data symbol; and
transmitting the bitstream.

17. The method of claim 16, further comprising binarizing the data symbol, wherein in the arithmetically encoding of the data symbol of the given slice, the data symbol of the given slice is the binarized data symbol.

18. The method of claim 16, wherein the slice coded temporally before the given slice is a slice coded immediately before the given slice.

19. The method of claim 16, wherein the slice coded temporally before the given slice is a slice in a lower level temporally closest to the given slice.

20. The method of claim 16, wherein the slice coded temporally before the given slice is a slice in a low-pass frame.

21. The method of claim 16, further comprising selecting one of context models for at least two slices coded temporally before the given slice, wherein in the resetting of the context model for the given slice, the context model for the slice coded temporally before the given slice is the selected context model.

22. A video decoding method including a method for performing context-based adaptive arithmetic decoding on a given slice in a high-pass frame in a temporal level in a temporally filtered hierarchical structure, the video decoding method comprising:
parsing a bitstream and extracting data about a block in the given slice to be reconstructed;
resetting a context model for the given slice to a context model for a slice decoded temporally before the given slice;
arithmetically decoding a bitstream corresponding to the block using the reset context model to generate a data symbol of the given slice;
updating the context model using a value of the data symbol;
dequantizing the data symbol to generate a transform coefficient;
performing inverse spatial transform on the transform coefficient to reconstruct a residual obtained by subtracting a predicted image from the block; and
adding the predicted image reconstructed by motion compensation to the reconstructed residual and reconstructing the block.

23. The method of claim 22, further comprising inverse-binarizing the data symbol.

24. The method of claim 22, wherein the slice decoded temporally before the given slice is a slice decoded immediately before the given slice.

25. The method of claim 22, wherein the slice decoded temporally before the given slice is a slice in a lower level temporally closest to the given slice.

26. The method of claim 22, wherein the slice decoded temporally before the given slice is a slice in a low-pass frame.

27. The method of claim 22, wherein the data about a block in the given slice to be constructed is the data of the slice coded temporally before the given slice, and the slice is referred for resetting the context model of the given slice

28. A method of context-based adaptive arithmetic coding of a video signal, the method comprising:
resetting a context model for a given slice to a different context model varying according to a type of a block in the given slice;
arithmetically encoding a data symbol of the block using the reset context model; and
updating the context model reset according to the type of the block.

29. The method of claim 28, further comprising binarizing the data symbol, wherein, in the arithmetically encoding of the data symbol of the given slice, the data symbol of the given slice is the binarized data symbol.

30. The method of claim 28:
wherein, in the resetting of the context model for the given slice, the different context model is a context model for a slice coded temporally before the given slice; and
wherein the slice has a same type of a block as the block of the given slice.

31. The method of claim 30, wherein the slice coded temporally before the given slice is a slice coded immediately before the given slice.

32. The method of claim 30, wherein the slice coded temporally before the given slice is a slice in a lower level that is temporally closest to the given slice.

33. The method of claim 30, wherein the slice coded temporally before the given slice is a slice in a low-pass frame.

34. The method of claim 28, further comprising selecting one of context models for at least two slices coded temporally before the given slice, wherein, in the resetting of the context model for the given slice, the context model for the slice coded temporally before the given slice is the selected context model.

35. A method of context-based adaptive arithmetic decoding of a video signal, the method comprising:
resetting a context model for a given slice comprising a block to a different context model varying according to a type of the block in the given slice;
arithmetically decoding a bitstream corresponding to the block using a context model corresponding to the block type to generate a data symbol of the given slice; and
updating the context model according to the block type using a value of the data symbol.

36. The method of claim 35, further comprising inverse-binarizing the data symbol.

37. The method of claim 35:
wherein, in the resetting of the context model for the given slice, the different context model is a context model for a slice decoded temporally before the given slice; and
wherein the slice has a same type of a block as the block of the given slice.

38. The method of claim 37, wherein the slice decoded temporally before the given slice is a slice decoded immediately before the given slice.

39. The method of claim 37, wherein the slice decoded temporally before the given slice is a slice in a lower level that is temporally closest to the given slice.

40. The method of claim 37, wherein the slice decoded temporally before the given slice is a slice in a low-pass frame.

41. A video coding method comprising:
subtracting a predicted image for a block from the block and generating a residual;
performing spatial transform on the residual to create a transform coefficient;
quantizing the transform coefficient;
resetting a context model for a given slice comprising the block to a different context model varying according to a type of the block;
arithmetically encoding a data symbol of the block using a context model reset according to the type of the block to generate a bitstream;
updating the context model reset according to the type of the block; and
transmitting the bitstream.

42. The method of claim 41, further comprising binarizing the data symbol, wherein, in the arithmetically encoding of the data symbol of the given slice, the data symbol of the given slice is the binarized data symbol.

43. The method of claim 41:
wherein, in the resetting of the context model for the given slice, the different context model is a context model for a slice coded temporally before the slice; and
wherein the slice has a same type of a block as the block of the given slice.

44. The method of claim 43, wherein the slice coded temporally before the given slice is a slice coded immediately before the given slice.

45. The method of claim 43, wherein the slice coded temporally before the given slice is a slice in a lower level that is temporally closest to the given slice.

46. The method of claim 43, wherein the slice coded temporally before the given slice is a slice in a low-pass frame.

47. The method of claim 41, firther comprising selecting one of context models for at least two slices coded temporally before the given slice, wherein, in the resetting of the context model for the given slice, the context model for the slice coded temporally before the given slice is the selected context model.

48. A video decoding method comprising:
parsing a bitstream and extracting data about a block to be reconstructed;
resetting a context model for a given slice comprising the block to a different context model varying according to a type of the block in the given slice;
arithmetically decoding a bitstream corresponding to the block using a context model corresponding to the block type to generate a data symbol of the given slice;
updating the context model according to the block type using a value of the data symbol;
dequantizing the data symbol to generate a transform coefficient;
performing inverse spatial transform on the transform coefficient to reconstruct a residual obtained by subtracting a predicted image from the block; and
adding the predicted image reconstructed by motion compensation to the reconstructed residual and reconstructing the block.

49. The method of claim 48, further comprising inversely binarizing the data symbol.

50. The method of claim 48:
wherein, in the resetting of the context model for the given slice, the different context model is a context model for a slice decoded temporally before the given slice; and
wherein the slice has a same type of a block as the block of the given slice.

51. The method of claim 50, wherein the slice decoded temporally before the given slice is a slice decoded immediately before the given slice.

52. The method of claim 50, wherein the slice decoded temporally before the given slice is a slice in a lower level that is temporally closest to the given slice.

53. The method of claim 50, wherein the slice decoded temporally before the given slice is a slice in a low-pass frame.

54. The method of claim 48, further comprising selecting one of context models for at least two slices decoded temporally before the given slice,
wherein, in the resetting of the context model for the given slice, the context model for the slice decoded temporally before the given slice is the selected context model.

55. A video coding method comprising:
subtracting a predicted image for a block from the block and generating a residual;
performing spatial transform on the residual to create a transform coefficient;
quantizing the transform coefficient;
resetting a context model for a given slice comprising the block as a predetermined initial value;
performing context-based adaptive arithmetic coding on a data symbol of the given slice using the context model and generating a final probability model;
performing another context-based adaptive arithmetic coding on the data symbol of the given slice using information about the final probability model as an initial value to generate a bitstream; and
transmitting the bitstream comprising information about the final probability model.

56. The method of claim 55, further comprising simplifying the final probability model and generating a simplified probability model,
wherein in the performing of context-based adaptive arithmetic coding, the information about the final probability model is information about the simplified probability model.

57. The method of claim 56, wherein the generating of the simplified probability model comprises calculating a difference between the final probability model and the initial value.

58. The method of claim 56, wherein the generating of the simplified probability model comprises calculating a difference between the final probability model and a context model for a base layer slice corresponding to the given slice.

59. The method of claim 55, further comprising binarizing the data symbol, wherein in performing the context-based adaptive arithmetic coding on the data symbol of the given slice, the data symbol of the given slice is the binarized data symbol.

60. The method of claim 55, wherein in the resetting of the context model for the slice containing the block, the predetermined initial value is a context model for a slice coded temporally before the given slice; and
wherein the slice has a same type of a block as the block of the given slice.

61. The method of claim 60, wherein the slice coded temporally before the given slice is a slice coded immediately before the given slice.

62. The method of claim 60, wherein the slice coded temporally before the given slice is a slice in a lower level that is temporally closest to the given slice.

63. The method of claim 60, wherein the slice coded temporally before the given slice is a slice in a low-pass frame.

64. The method of claim 55, further comprising selecting one of context models for at least two slices coded temporally before the slice containing the block, wherein the context model for the slice coded temporally before the given slice is the selected context model.

65. A video decoding method comprising:
extracting an initial value of a context model in a given slice comprising a block to be reconstructed from a bitstream;
resetting a context model for the given slice using the initial value;
arithmetically decoding a bitstream corresponding to the block using the reset context model to generate a data symbol of the given slice; and
updating the context model using a value of the data symbol;
dequantizing the data symbol to generate a transform coefficient;
performing inverse spatial transform on the transform coefficient to reconstruct a residual obtained by subtracting a predicted image from the block; and
adding the predicted image reconstructed by motion compensation to the reconstructed residual and reconstructing the block.

66. The method of claim 65, further comprising inverse-binarizing the data symbol, wherein, in the arithmetically decoding the bitstream, the data symbol is a binarized data symbol.

67. The method of claim 65, wherein the initial value of the context model comprises a simplified final probability model obtained by:
resetting the context model for the given slice as a predetermined initial value;
performing context-based adaptive arithmetic coding on a data symbol of the given slice using the context model and generating a final probability model; and
simplifying the final probability model.

68. A video encoder for performing context-based adaptive arithmetic coding on a given slice in a high-pass frame in a temporal level in a temporally filtered hierarchical structure, the video encoder comprising:
a unit which subtracts a predicted image for a block in the given slice from the block and generates a residual;
a unit which performs spatial transform on the residual to create a transform coefficient;
a unit which quantizes the transform coefficient;
a unit which resets a context model for the given slice to a context model for a slice coded temporally before the given slice;
a unit which arithmetically encodes a data symbol comprising the quantized transform coefficient using the reset context model to generate a bitstream;
a unit which updates the context model using a value of the arithmetically encoded data symbol; and
a unit which transmits the bitstream.

69. A video decoder for performing context-based adaptive arithmetic decoding on a given slice in a high-pass frame in a temporal level in a temporally filtered hierarchical structure, the video decoder comprising:
a unit which parses a bitstream and extracts data about a block to be reconstructed in the given slice;
a unit which resets a context model for the given slice to a context model for a slice decoded temporally before the given slice;
a unit which arithmetically decodes a bitstream corresponding to the block using the reset context model to generate a data symbol of the given slice;
a unit which updates the context model using a value of the data symbol;
a unit which dequantizes the data symbol to generate a transform coefficient;
a unit which performs inverse spatial transform on the transform coefficient to reconstruct a residual obtained by subtracting a predicted image from the block; and
a unit which adds the predicted image reconstructed by motion compensation to the reconstructed residual and reconstructs the block.

70. A video encoder comprising:
a unit which subtracts a predicted image for a block to be reconstructed from the block and generates a residual;
a unit which performs spatial transform on the residual to create a transform coefficient;
a unit which quantizes the transform coefficient;
a unit which resets a context model for a given slice comprising the block to a different context model varying according to a type of the block;
a unit which arithmetically encodes a data symbol of the block using a context model reset according to the type of the block to generate a bitstream;
a unit which updates the context model reset according to the type of the block; and
a unit which transmits the bitstream.

71. A video decoder comprising:
a unit which parses a bitstream and extracts data about a block to be reconstructed;
a unit which resets a context model for a given slice comprising the block to a different context model varying according to a type of the block in the given slice;
a unit which arithmetically decodes the bitstream corresponding to the block using a context model reset according to the type of the block to generate a data symbol of the given slice;
a unit which updates the context model reset according to the type of the block using a value of the data symbol;
a unit which dequantizes the data symbol to generate a transform coefficient;
a unit which performs inverse spatial transform on the transform coefficient to reconstruct a residual obtained by subtracting a predicted image from the block; and
a unit which adds the predicted image reconstructed by motion compensation to the reconstructed residual and reconstructs the block.

72. A video encoder comprising:
a unit which subtracts a predicted image for a block from the block and generates a residual;
a unit which performs spatial transform on the residual to create a transform coefficient;
a unit which quantizes the transform coefficient;
a unit which resets a context model for a given slice comprising the block as a predetermined initial value;
a unit which performs context-based adaptive arithmetic coding on a data symbol of the given slice using the context model and generates a final probability model;
a unit which performs another context-based adaptive arithmetic coding on the data symbol of the given slice using information about the final probability model as an initial value to generate a bitstream; and
a unit which transmits the bitstream comprising information about the final probability model.

73. A video decoder comprising:
a unit which extracts an initial value of a context model in a given slice comprising a block to be reconstructed from a bitstream;
a unit which resets a context model for the given slice as the initial value;
a unit which arithmetically decodes a bitstream corresponding to the block to be reconstructed using the context model to generate a data symbol of the given slice;
a unit which updates the context model using a value of the data symbol;
a unit which dequantizes the data symbol to generate a transform coefficient;
a unit which performs inverse spatial transform on the transform coefficient to reconstruct a residual obtained by subtracting a predicted image from the block; and
a unit which adds the predicted image reconstructed by motion compensation to the reconstructed residual and reconstructs the block.

74. A computer-readable recording program medium as programs that can be executed in the method of claim 1.

75. A computer-readable recording program medium as programs that can be executed in the method of claim 9.

76. A computer-readable recording program medium as programs that can be executed in the method of claim 16.

77. A computer-readable recording program medium as programs that can be executed in the method of claim 22.

78. A computer-readable recording program medium as programs that can be executed in the method of claim 28.

79. A computer-readable recording program medium as programs that can be executed in the method of claim 35.

80. A computer-readable recording program medium as programs that can be executed in the method of claim 41.

81. A computer-readable recording program medium as programs that can be executed in the method of claim 48.

82. A computer-readable recording program medium as programs that can be executed in the method of claim 55.

83. A computer-readable recording program medium as programs that can be executed in the method of claim 65.
